(19) United States
(12) Patent Application Publication
(10) Pub. No.: US 2013/0010643 A1
(43) Pub. Date: Jan. 10, 2013

(54) Method and apparatus for loop path search in mesh network

(76) Inventor: Lei Yu, Shenzhen (CN)

(21) Appl. No.: 13/582,292

(22) PCT Filed: Oct. 13, 2010
(86) PCT No.: PCT/CN2010/077707

§ 371 Date: Aug. 31, 2012

(30) Foreign Application Priority Data
Mar. 26, 2010 (CN) 201010140691.7

(51) Int. Cl. H04L 12/28

(52) U.S. Cl. 370/255

(57) ABSTRACT

The present invention discloses a method and apparatus for loop path search in a mesh network, comprising: a network side searching for all nodes adjacent to node v1 in the mesh network, and deleting all edges formed by node v1 and nodes directly connected to node v1 in the mesh network; the network side performing calculation for all obtained nodes adjacent to node v1 through a K shortest path algorithm to obtain all paths between all nodes adjacent to node v1; and the network side traversing all obtained paths between all nodes adjacent to node v1, and adding node v1 at start and termination of each path to finish search for all loop paths of node v1 in the Mesh network. With the present invention, the problem of low loop path search efficiency existed in the conventional method is solved, and the loop path search efficiency is improved.

### FIELD OF THE INVENTION

The present invention relates to the field of network, in particular to a method and an apparatus for loop path search in a mesh network.

### BACKGROUND OF THE INVENTION

A loop path refers to one communication path P=[v1, v2, vn, v1] (n≧3) in a mesh network G(V, E). In the path, other nodes are different from each other except a start node and a termination node. This path is also referred to as one loop path of the node v1.

According to a conventional loop path calculation method, the path p=[v1, vm, vn, v1] is one loop path of the node v1. A recursive traversal mode is employed in the conventional loop path calculation method. The mesh network is shown in FIG. 1, and the flow chart of calculating the loop path of the node v1 is shown in FIG. 2 and described as follows.

Step 1: all nodes vm adjacent to the node v1 are searched out, wherein vm={v□V|(v1, v) □E}.

Step 2: information about paths between the node v1 and the adjacent nodes is recorded; and all nodes vn adjacent to the nodes vm are searched out, wherein vn={v□V|(vm, v)□E}.

Step 3: it is checked whether the node v1 is adjacent to the nodes vn, if so, one loop path p=[v1, vm, vn, v1] of the node v1 is found out; otherwise, Step 2 is repeated.

In the conventional loop path calculation method, in order to find out all loop paths of the node v1, the time complexity is more than or equal to O(Kn3) (n is the number of nodes in the mesh network), therefore, the conventional method has a problem of low loop path search efficiency.

### SUMMARY OF THE INVENTION

The present invention provides a method and an apparatus for loop path search in a mesh network, which solves the problem of low loop path search efficiency in the conventional method and improves the loop path search efficiency.

To solve the above problem, the technical solution of the present invention is realized as follows.

A method for loop path search in a mesh network is provided, and the method comprises:

searching for all nodes adjacent to a node v1 in the mesh network, and deleting all edges formed by the node v1 and nodes directly connected to the node v1 in the mesh network;

performing calculation for all the obtained nodes adjacent to the node v1 through a path algorithm to obtain all paths between all the nodes adjacent to the node v1; and

traversing all the paths, obtained through calculation, between all the nodes adjacent to the node v1, and adding the node v1 at a start and a temination of each path to finish a search for all loop paths of the node v1 in the Mesh network.

Preferably, a start node and a termination node of each of all the paths obtained through calculation are different and are nodes adjacent to the node v1.

Preferably, after the step of searching for all the nodes adjacent to the node vi in the mesh network, the method further comprises: storing information about all the obtained nodes adjacent to the node v1;

after the step of obtaining all the paths through calculation, the method further comprises: storing information about all the obtained paths between all the nodes adjacent to the node v1;

after the step of finishing the search for all the loop paths of the node v1 in the mesh network, the method further comprises: storing information about the obtained loop paths of the node v1.

Preferably, a method for performing calculation for all the obtained nodes adjacent to the node v1 comprises:

performing calculation for all the obtained nodes adjacent to the node v1 through a K shortest path algorithm.

Preferably, all the loop paths comprise two parts:

one part is paths between nodes adjacent to the node v1; and the other part is paths between the node v1 and the nodes adjacent to the node v1.

An apparatus for loop path search in a mesh network is provided, and the apparatus comprises: a node search module, a calculation module and a loop path seeking module; wherein

the node search module is configured to search for all nodes adjacent to a node v1 in the mesh network, delete all edges formed by the node v1 and nodes directly connected to the node v1 in the mesh network, and send information about all the obtained nodes adjacent to the node v1 to the calculation module;

the calculation module is configured to perform calculation for all the obtained nodes adjacent to the node v1 through a path algorithm to obtain all paths between all the nodes adjacent to the node v1, and send all the obtained paths to the loop path seeking module; and

the loop path seeking module is configured to traverse all the obtained paths between all the nodes adjacent to the node v1, and add the node v1 at a start and a termination of each path to finish a search for all loop paths of the node v1 in the Mesh network.

Preferably, a start node and a termination node of each of all the paths, which are obtained through calculation of the calculation module, between all the nodes adjacent to the node v1 are different and are nodes adjacent to the node v1.

Preferably, the apparatus further comprises: a storage module, configured to store the information about all the nodes, which are obtained by the node search module, adjacent to the node v1; further configured to store information about all the paths, which are obtained by the calculation module, between all the nodes adjacent to the node v1; and further configured to store information about the loop paths of the node v1 which are obtained by the loop path seeking module.

Preferably, the calculation module is configured to: when performing calculation for all the obtained nodes adjacent to the node v1, perform calculation for all the obtained nodes adjacent to the node v1 through a K shortest path algorithm.

Preferably, all the loop paths comprise two parts: one part is paths between nodes adjacent to the node v1; and the other part is paths between the node v1 and the nodes adjacent to the node v1.

Compared with the conventional art, by the application of the present invention, in aid of a K Shortest Path (KSP) algorithm, the loop paths are divided into two parts: one part is paths between adjacent nodes and the other part is paths from the adjacent nodes to the node v1, the time complexity according to the method in the present invention is the time complexity of the selected KSP algorithm, therefore the current problem of low loop path search efficiency in the conventional method is solved, the loop path search efficiency is improved, and the load of the system is reduced.

### BRIEF DESCRIPTION OF THE DRAWINGS

FIG. 1 is a diagram of a traversal process when loop paths of a node v1 are calculated in the conventional method;

FIG. 2 is a flow chart of calculating loop paths of a node v1 in the conventional method;

FIG. 3 is a flow chart of searching for loop paths of a node v1 in a mesh network in an embodiment of the present invention;

FIG. 4 is a structure diagram of an apparatus for loop path search in a mesh network in an embodiment of the present invention;

FIG. 5 is a diagram of a loop path;

FIG. 6 is a diagram of a mesh network in an embodiment of the present invention, based on which the embodiment is explained and described;

FIG. 7 is a diagram for describing calculation of paths between nodes adjacent to the node v1 in an embodiment of the present invention; and

FIG. 8 is a diagram of a traversal process when loop paths of the node v1 are calculated in an embodiment of the present invention.

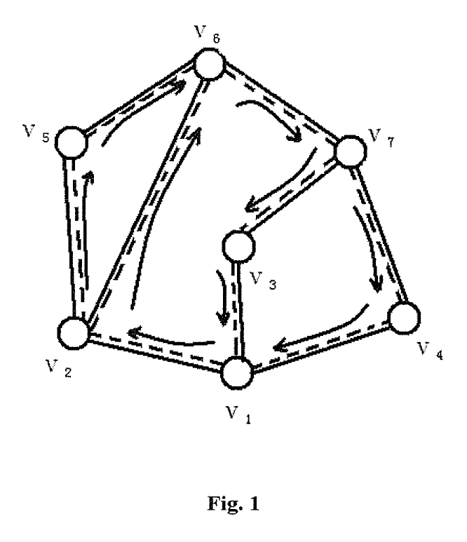

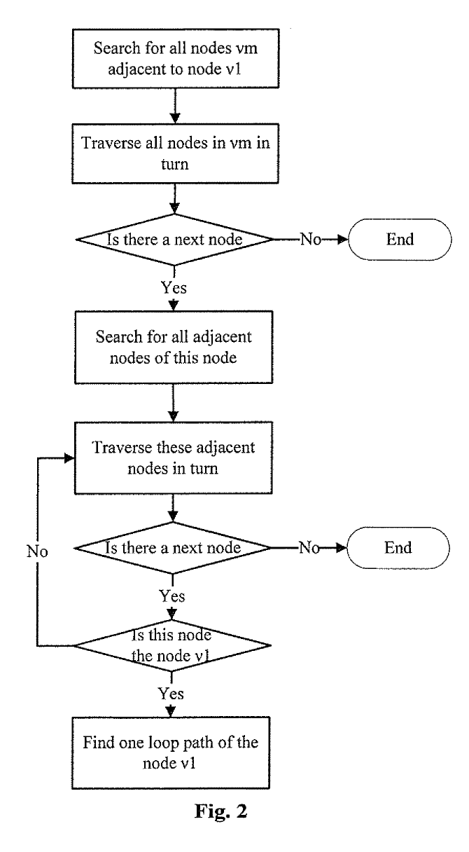

### DETAILED DESCRIPTION OF THE EMBODIMENTS

The present invention will be further described below with reference to drawings and embodiments.

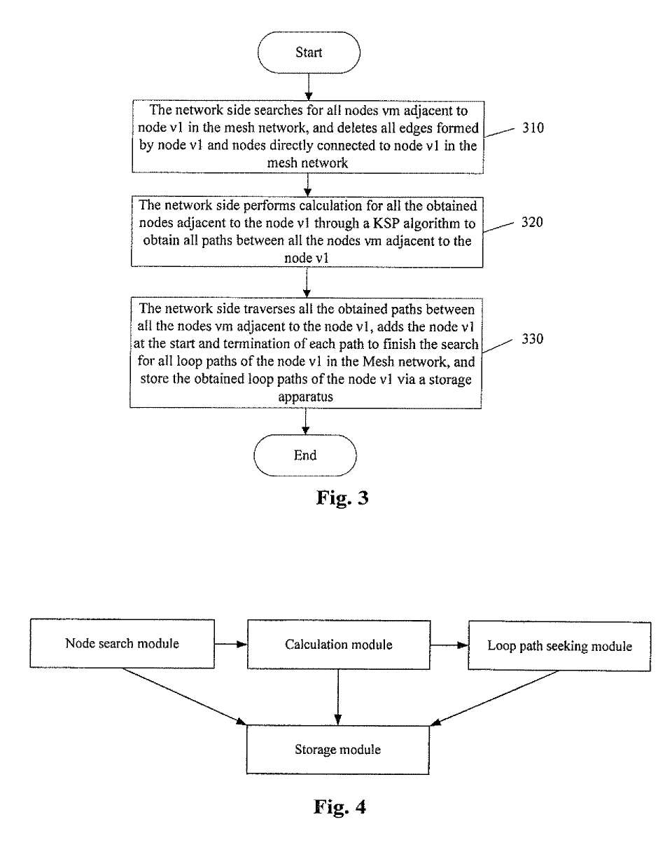

As shown in FIG. 3, in an embodiment of the present invention, the procedure of searching for loop paths of a node v1 in a mesh network G(V, E) comprises the following steps.

Step 310: A network side searches for all nodes vm adjacent to the node v1 in the mesh network, and deletes all edges formed by the node v1 and nodes directly connected to the node v1 in the mesh network;

wherein vm={v□V|(v1, v)□E}.

After the network side finds out all the nodes vm adjacent to the node v1 in the mesh network, the method also comprises a step of storing information about all the obtained nodes adjacent to the node v1 via a storage apparatus.

Step 320: The network side performs calculation for all the obtained nodes adjacent to the node v1 through a K shortest path (KSP) algorithm to obtain all paths between all the nodes vm adjacent to the node v1.

After the network side obtains all the paths between all the nodes vm adjacent to the node v1, the method also comprises a step of storing information about all the obtained paths between all the nodes vm adjacent to the node v1 via a storage apparatus.

Wherein a start node and a termination node of each of the paths obtained by the network side are different and are nodes adjacent to the node v1.

Step 330: The network side traverses all the obtained paths between all the nodes vm adjacent to the node v1, adds the node v1 at the start and termination of each path to finish the search for all loop paths of the node v1 in the Mesh network, and stores the obtained loop paths of the node v1 via a storage apparatus.

As shown in FIG. 4, an apparatus for loop path search in a mesh network comprises a node search module, a calculation module and a loop path seeking module; wherein

the node search module is configured to search for all nodes adjacent to the node v1 in the mesh network, delete all edges formed by the node v1 and nodes directly connected to node v1 in the mesh network, and send information about all the obtained nodes adjacent to the node v1 to the calculation module;

the calculation module is configured to perform calculation for all the obtained nodes adjacent to the node v1 through a KSP algorithm to obtain all paths between all the nodes adjacent to the node v1, and send all the obtained paths to the loop path seeking module;

the loop path seeking module is configured to traverse all the obtained paths between all the nodes adjacent to the node v1, and add the node v1 at the start and termination of each path to finish the search for all loop paths of the node v1 in the Mesh network.

The start node and termination node of each of all the paths, which are obtained by the calculation module, between all nodes adjacent to the node v1 are different and are nodes adjacent to the node v1,

The storage module is configured to store the information about all the nodes, which are obtained by the node search module, adjacent to node v1; store information about all the paths, which are obtained by the calculation module, between all the nodes adjacent to the node v1; and store information about the loop paths, which are obtained by the loop path seeking module, of the node v1.

One loop path also may be understood as a path with the same start node and termination node. The method defines the loop path of the node vm, that is, in the path, vm serves as both the start node and the termination node of the path, which can be expressed as p=[vm, v1, . . . vn, vm] (n≧2).

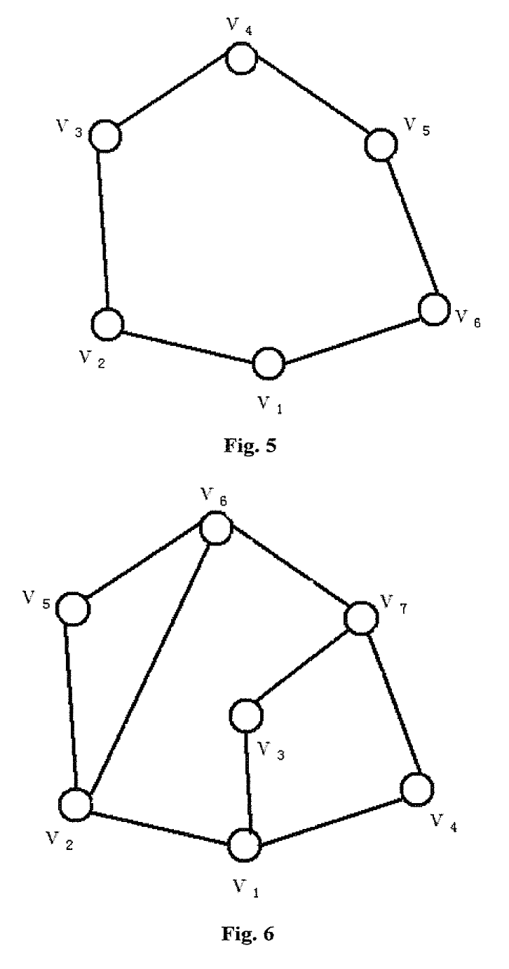

With reference to FIG. 5, one loop path of the node v1 is p=[v1, v2, v3, v4, v5, v6, v1]. This path can be understood to be formed by two parts, one part is the path pa=[v2, v3, v4, v5, v6] between adjacent nodes (v2, v6) of the node v1, and the other part is paths pb=[v1, v2] and pc=[v1, v6] between the node v1 and the adjacent nodes (v2, v6). So, the loop path to be obtained is the sum of the two parts of paths, that is, p=[v1, v2, v3, v4, v5, v6, v1]=pb+pa+pc. The above idea can be promoted to general situations, that is, searching for all the loop paths of a certain node vm in one mesh network G(V, E).

The specific implementation process will be described below with reference to drawings. As shown in FIG. 6, suppose that it is required to search for all the loop paths of the node v1 in FIG. 6.

First, nodes v2, v3 and v4 adjacent to the node v1 are obtained.

Then, paths between each two of the three nodes are calculated respectively, and KSP algorithm is recommended to calculate all the paths between two nodes.

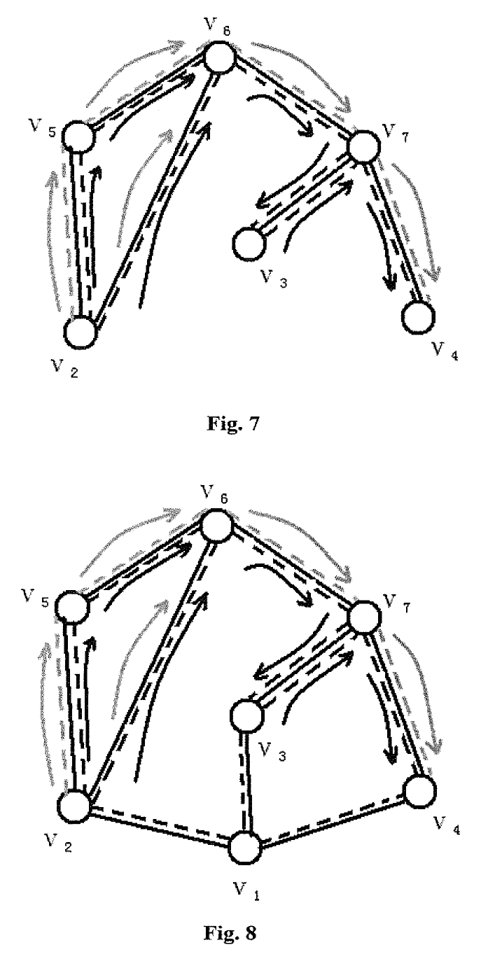

After the calculation is finished, the following paths can be obtained (see FIG. 7):

p123=[v2, v5, v6, v7, v3];

p223=[v2, v6, v7, v3];

p124=[v2, v5, v6, v7, v4];

p224=[v2, v6, v7, v4];

p134=[v3, v7, v4].

Paths between the node v1 and the adjacent nodes v2, v3 and v4 are known as follows:

p112=[v1, v2];

p113=[v1, v3];

p114=[v1, v4].

The two parts are added together to obtain all the loop paths of the node v1 (see FIG. 8):

p11=[v1, v2, v5, v6, v7, v3, v1];

p21=[v1, v2, v6, v7, v3, v1];

p31=[v1, v2, v5, v6, v7, v4, v1];

p41=[v1, v2, v6, v7, v4, v1];

p51=[v1, v3, v7, v4, v1];

the flow ends.

In accordance with the embodiments of the present invention, the problem of low loop path search efficiency existed in the conventional method is solved, and the loop path search efficiency is improved.

The above contents just describe preferable embodiments of the present invention, the protection scope of the present invention is not limited thereto, any changes or replacements easily made by person skilled in the art within the technical scope disclosed in the present invention should be included within the protection scope of the present invention. Therefore, the protection scope of the present invention should be subject to the protection scope defined by the claims.

1. A method for loop path search in a mesh network, wherein the method comprises:
searching for all nodes adjacent to a node v1 in the mesh network, and deleting all edges formed by the node v1 and nodes directly connected to the node v1 in the mesh network;
performing calculation for all the obtained nodes adjacent to the node v1 through a path algorithm to obtain all paths between all the nodes adjacent to the node v1; and
traversing all the paths, obtained through calculation, between all the nodes adjacent to the node v1, and adding the node v1 at a start and a termination of each path to finish a search for all loop paths of the node v1 in the Mesh network.

2. The method according to claim 1, wherein a start node and a termination node of each of all the paths obtained through calculation are different and are nodes adjacent to the node v1.

3. The method according to claim 2, wherein
after the step of searching for all the nodes adjacent to the node v1 in the mesh network, the method further comprises: storing information about all the obtained nodes adjacent to the node v1;
after the step of obtaining all the paths through calculation, the method further comprises:
storing information about all the obtained paths between all the nodes adjacent to the node v1;
after the step of finishing the search for all the loop paths of the node v1 in the mesh network, the method further comprises: storing information about the obtained loop paths of the node v1.

4. The method according to claim 1, wherein a method for performing calculation for all the obtained nodes adjacent to the node v1 comprises:
performing calculation for all the obtained nodes adjacent to the node v1 through a K shortest path algorithm.

5. The method according to claim 1, wherein all the loop paths comprise two parts:
one part is paths between nodes adjacent to the node v1; and the other part is paths between the node v1 and the nodes adjacent to the node v1.

6. An apparatus for loop path search in a mesh network, wherein the apparatus comprises: a node search module, a calculation module and a loop path seeking module; wherein
the node search module is configured to search for all nodes adjacent to a node v1 in the mesh network, delete all edges formed by the node v1 and nodes directly connected to the node v1 in the mesh network, and send information about all the obtained nodes adjacent to the node v1 to the calculation module;
the calculation module is configured to perform calculation for all the obtained nodes adjacent to the node v1 through a path algorithm to obtain all paths between all the nodes adjacent to the node v1, and send all the obtained paths to the loop path seeking module; and
the loop path seeking module is configured to traverse all the obtained paths between all the nodes adjacent to the node v1, and add the node v1 at a start and a termination of each path to finish a search for all loop paths of the node v1 in the Mesh network.

7. The apparatus according to claim 6, wherein
a start node and a termination node of each of all the paths, which are obtained through calculation of the calculation module, between all the nodes adjacent to the node v1 are different and are nodes adjacent to the node v1.

8. The apparatus according to claim 7, further comprising: a storage module, configured to store the information about all the nodes, which are obtained by the node search module, adjacent to the node v1; further configured to store information about all the paths, which are obtained by the calculation module, between all the nodes adjacent to the node v1; and further configured to store information about the loop paths of the node v1 which are obtained by the loop path seeking module.

9. The apparatus according to claim 6, wherein the calculation module is configured to: when performing calculation for all the obtained nodes adjacent to the node v1, perform calculation for all the obtained nodes adjacent to the node v1 through a K shortest path algorithm.

10. The apparatus according to claim 6, wherein all the loop paths comprise two parts: one part is paths between nodes adjacent to the node v1; and the other part is paths between the node v1 and the nodes adjacent to the node v1.

11. The method according to claim 2, wherein a method for performing calculation for all the obtained nodes adjacent to the node v1 comprises:
performing calculation for all the obtained nodes adjacent to the node v1 through a K shortest path algorithm.

12. The method according to claim 3, wherein a method for performing calculation for all the obtained nodes adjacent to the node v1 comprises:
performing calculation for all the obtained nodes adjacent to the node v1 through a K shortest path algorithm.

13. The method according to claim 2, wherein all the loop paths comprise two parts:
one part is paths between nodes adjacent to the node v1; and the other part is paths between the node v1 and the nodes adjacent to the node v1.

14. The method according to claim 3, wherein all the loop paths comprise two parts:
one part is paths between nodes adjacent to the node v1; and the other part is paths between the node v1 and the nodes adjacent to the node v1.

15. The apparatus according to claim 7, wherein the calculation module is configured to: when performing calculation for all the obtained nodes adjacent to the node v1, perform calculation for all the obtained nodes adjacent to the node v1 through a K shortest path algorithm.

16. The apparatus according to claim 8, wherein the calculation module is configured to: when performing calculation for all the obtained nodes adjacent to the node v1, perform calculation for all the obtained nodes adjacent to the node v1 through a K shortest path algorithm.

17. The apparatus according to claim 7, wherein all the loop paths comprise two parts: one part is paths between nodes adjacent to the node v1; and the other part is paths between the node v1 and the nodes adjacent to the node v1.

18. The apparatus according to claim 8, wherein all the loop paths comprise two parts: one part is paths between nodes adjacent to the node v1; and the other part is paths between the node v1 and the nodes adjacent to the node v1.
